(19) United States
(12) Patent Application Publication
(10) Pub. No.: US 2018/0070625 A1
(43) Pub. Date: Mar. 15, 2018

(54) METHOD FOR PRODUCING A PARTICULATE TOBACCO PRODUCT, DEVICE OF THE TOBACCO PROCESSING INDUSTRY AND USE OF THE DEVICE

(71) Applicant: HAUNI MASCHINENBAU GMBH, Hamburg (DE)

(72) Inventors: Helmut VOSS, Neumuenster (DE); Carlo SCHENKE, Schwarzenbek (DE)

(73) Assignee: HAUNI MASCHINENBAU GMBH, Hamburg (DE)

(21) Appl. No.: 15/816,239

(22) Filed: Nov. 17, 2017

Related U.S. Application Data
(63) Continuation of application No. PCT/EP2016/059786, filed on May 2, 2016.

(30) Foreign Application Priority Data
May 20, 2015 (DE) 10 2015 107 971.2

(51) Int. Cl. A24B 7/00; A24B 13/00

(52) U.S. Cl. CPC A24B 7/00; B26F 1/384; A24B 13/00

(57) ABSTRACT

Method and device for producing a particulate tobacco product. The method includes conveying a supplied flat starting material comprising tobacco along a processing plane to a punching station; punching out at least one tobacco particle from the starting material using a punching tool of the punching station; and supplying the at least one punched-out tobacco particles as a particulate tobacco product.

### CROSS-REFERENCE TO RELATED APPLICATIONS

The present application is a Continuation of International Application No. PCT/EP2016/059786 filed May 2, 2016 and claims priority under 35 U.S.C. § § 119(a) and 365 of German Patent Application No. 10 2015 107 971.2 filed May 20, 2015. The disclosure of International Application No. PCT/EP2016/059786 is expressly incorporated by reference herein in its entirety.

### BACKGROUND

### 1. Field of the Invention

Embodiments of the invention relate to a method for producing a particulate tobacco product, a device of the tobacco processing industry for producing a particulate tobacco product, and the use of the device.

### 2. Discussion of Background Information

Tobacco leaves consist of leaf tobacco, the lamina and tobacco ribs or respectively stems. For the further processing, the lamina is separated from the tobacco ribs. During the preparation of the tobacco, the tobacco ribs and the leaf tobacco are treated separately from one another. Generally, the lamina is conditioned, i.e. subjected to a treatment using moisture and heat, and subsequently cut and dried. In further method steps, the tobacco ribs and the cut leaf material are blended together again for further processing, for example aromatized and finally processed further to form a tobacco strand.

The basic principles of the production of cut tobacco are shown in detail in the book “Tobacco Encyclopedia,” published by Ernst Voges, 1984, in the chapter “Manufacture,” pages 408 ff, in particular under the heading “The Production of Cut Tobacco.”

A method for separating the lamina of the tobacco leaf from the ribs and stems is the threshing of the tobacco leaves. The lamina in this case is chopped off from the stems and ribs. In this method, however, a not insignificant proportion of very small tobacco particles and tobacco dust is produced, the presence thereof in the tobacco material being undesirable or respectively not being supposed to exceed certain limits. This tobacco material is thus removed from the process and reconstituted in a costly method. The tobacco sheet thus produced may be added again to the tobacco production process, since in most production methods of the tobacco processing industry it is desirable for the raw material to be fully utilized, primarily with regard to the high costs thereof.

It is also known to cut the tobacco leaves in order to obtain pieces of equal size. A method in which tobacco leaves are cut in the longitudinal and transverse directions by means of two separate cutting apparatuses, namely a longitudinal cutter and a transverse cutter, is for example disclosed in U.S. Pat. No. 3,128,775, the disclosure of which is expressly incorporated by reference herein in its entirety. The small tobacco pieces, which are produced in two separate operating steps and which are preferably square, result in small pieces which exclusively consist of the lamina and also those which contain a more or less large proportion of a tobacco leaf stem or a rib piece. According to U.S. Pat. No. 3,128,775, these two fractions are separated. The rib-containing pieces are threshed in order to release the lamina from the ribs.

A similar method is also disclosed in DE 2 921 025, the disclosure of which is expressly incorporated by reference herein in its entirety. For processing tobacco leaves for cigarette tobacco, the tobacco leaf is initially cut. The resulting tobacco particles are sifted by means of air in order to separate the lamina particles from the rib-containing particles. The rib-containing tobacco particles are subsequently also threshed in order to obtain the lamina. The small rib-free tobacco pieces may be supplied to the extrusion process for producing cigarettes, optionally after prior conditioning and/or storage.

In order to supply the aforementioned tobacco sheet made of reconstituted tobacco to the cigarette production process, it is necessary to chop said tobacco sheet. To this end, EP 0 150 473, the disclosure of which is expressly incorporated by reference herein in its entirety, proposes an apparatus which comprises a blade roller which cooperates with a fixed counterblade. The tobacco sheet is supplied to this arrangement in a direction of conveyance and in a first cutting process is cut between the rotating blade and the fixed counterblade transversely to the direction of conveyance. Subsequently, the tobacco sheet is advanced in the direction of conveyance so that a subsequent second cutting of the tobacco sheet, in which the rotating blade arrangement again cooperates with the fixed counterblade, results in a plurality of small individual pieces of the tobacco sheet being cut off. In other words, in the first cutting process the small tobacco pieces are cut on the one side thereof and in the second cutting process the small tobacco pieces are cut on the opposing side thereof. A cut corresponding to half of the length thereof is made on their lateral edges with each cutting process.

### SUMMARY

In view of this prior art, embodiments of the invention provide a method for producing a particulate tobacco product, a device of the tobacco processing industry for producing a particulate tobacco product and the use of such a device. According to embodiments, an improvement with regard to the flexibility and the efficiency of the production of the particulate tobacco product is to be achieved.

According to embodiments, a method for producing a particulate tobacco product includes:
conveying a supplied flat starting material including tobacco to a punching station in a processing plane,
punching out at least one tobacco particle from the starting material using a punching tool of the punching station, and
supplying a plurality of punched-out tobacco particles as a particulate tobacco product.

Within the context of the present description, the term “punching out” is understood in that a flat part, in this case the tobacco particle, is produced from a starting material via a punching tool by pressing or by impact. In this case, the starting material is moved between the punching tool and a counterpiece and the pressure required for the processing is exerted on the starting material located between the punching tool and the counterpiece. The counterpiece is not part of the punching tool. The punching tool includes a punching blade, for example, a strip made of carbon steel. Along a cutting line of the punching blade, the flat part is cut out from the starting material by shearing. The flat part is cut out from the starting material by one or more punching processes. A flat part is produced for each punching process, but preferably a plurality of flat parts is produced. The product produced is ejected, if required, from the punching tool, for example, via compressed air, a spring-mounted ejection plate or by a resilient mass. For example, a rubber material is provided in the intermediate spaces of the punching blade, the rubber material being compressed during the punching process. After the punching process is finished, the resilient material relaxes and the flat part is ejected.

Advantageously, the method for producing a particulate tobacco product according to features of the invention provides the following advantages. When punching out the tobacco particles, neither tobacco dust nor other small tobacco particles are produced as by-products, which are either lost from the process or have to be reconstituted in a costly manner. The tobacco is loaded with less tobacco dust and during the production process fewer undesirable by-products are present. Thus the punching-out of the tobacco particles is highly efficient and very economical.

Moreover, the punching-out of the tobacco particles is very gentle for the tobacco material. The tobacco leaves are only subjected to low mechanical loads.

A further important advantage of the method according to the invention is that the punching tool defines the shape and size of the punched-out tobacco particles. Thus, on the one hand, the possibility is provided to produce tobacco particles in practically any shape and size. On the other hand, it is possible to adjust a shape and size distribution of the tobacco particles by a corresponding construction of the punching tool.

By the shape and size of the tobacco particles being adjusted so as to be cut to size, the possibility is provided of supplying these tobacco particles directly to the extrusion process during the cigarette production process. Further conditioning and preparation steps are possible but the cutting of the tobacco product may be dispensed with. The shape of the produced tobacco particles may also be optimized with regard to their properties subsequently in the process. For example, a shape is selected which produces a desired increase in volume during drying and expansion. This is determined by the three-dimensional microstructure of the individual tobacco particle which, for example, is twisted or bent. Moreover, shapes of tobacco particles may be produced which interlock with one another so that in this manner the desired volume is produced.

With regard to the shape and size distribution, for example, it is possible to produce exclusively tobacco particles which are identical according to the size and shape thereof. The tobacco product produced is thus very uniform. It is possible to provide a tobacco strand of the highest uniformity with the best quality values and with very smooth running properties. The uniformity is also advantageous for the conditioning of the tobacco product, since with a uniform starting material the anticipated results may be achieved in a very reliable manner.

It is also possible that the punching tool is designed such that different shapes and/or sizes of tobacco particles are produced. The shape and size distribution may in turn be adjusted with regard to the volumetric properties of the produced tobacco product. It is also possible to blend together a particulate tobacco product of different types of tobacco and/or different shapes and/or sizes of tobacco particles for adjusting a specific recipe. Also, in this case, a high-value blend of very uniform quality is in turn supplied for producing a tobacco strand.

Finally, the punching method according to features of the invention may be implemented at low constructional cost. This relates, in particular, to changing the punched-out formats and sizes of the tobacco particles. It is simply necessary to change the punching tool, i.e., one component, in order to produce different sizes and/or shapes or different distributions of size and shape of the tobacco particles.

The method according to the embodiments of the invention is finally advantageously suitable for practically all tobacco types and is also preferably used for tobacco sheets, i.e., reconstituted tobacco material. Reconstituted tobacco, i.e., a tobacco sheet, is advantageously able to be processed easily in the punching process, although its mechanical properties markedly differ from those of the tobacco leaves. If the tobacco product produced from tobacco sheet is subsequently blended with the tobacco product which is produced from tobacco leaves, a very uniform blend may be achieved, since the size and shape coincide or are at least very similar. In other words, the possibility is provided to distribute the reconstituted tobacco material very uniformly in the tobacco strand.

According to an advantageous embodiment, the method is further developed in that the punching tool includes a punching blade with a closed cutting line. A shape of the punched-out tobacco particle is determined by the closed shape of the cutting line. Advantageously, by the use of such a punching blade, the possibility is provided to define accurately the shape of the punched-out tobacco particles. This not only relates to their shape but also their size. It is preferably provided that the punching blade is designed such that a plurality of tobacco particles is preferably able to be produced in a single punching process or procedure. The punching tool is, for example, a roller punch or a punch plate. Since different punched shapes or different sizes of one and the same punched shape may be provided on such a punch, the resulting blend of the tobacco particles is adjusted.

Moreover, it is preferably provided that the at least one tobacco particle is punched out in a single uninterrupted operating step from the starting material. In other words, therefore, the at least one tobacco particle, preferably a plurality of tobacco particles, is punched out in a single operating step, i.e., in a single punching or pressing process. This relates both to the punching-out by a roller punch and the punching-out by a stamp. Whilst, when punching out by the stamp, the cutting line along the periphery of the tobacco particle cuts out the flat part from the starting material practically at the same time at all points, with a roller punch the cutting line extends along a contact line between the roller punch and the counter-support. The flat part is thus cut out at the same time along one or more points on its periphery. In both cases, it is a single and uninterrupted process or respectively cutting process in which the tobacco particle is punched out of the starting material.

Preferably, the method for producing a particulate tobacco product is developed in that the tobacco particle is punched out by continuous shearing along the closed cutting line of the punching tool in the one operating step, entirely from the starting material. According to the above embodiment, the tobacco particle is cut out from the starting material by a single punching tool. According to further embodiments, it is provided that the tobacco particle is cut out from the starting material in two successive punching processes. In such an embodiment, the punching out would not take place in a single uninterrupted operating step but in two individual operating steps which are separate from one another.

According to a further advantageous embodiment, it is provided that the starting material is supplied in a plurality of individual superimposed layers to the punching station and with each punching-out process a plurality of tobacco particles which are superimposed in a congruent manner are punched out at the same time. Advantageously, therefore, a plurality of tobacco particles is punched out at the same time in a single punched shape. This increases the throughput of the punching method and thus the efficiency. The superimposed layers of the starting material, which for example is tobacco leaves or tobacco sheet, are not compressed with one another. Thus it is ensured that the punched-out tobacco particles may be easily released from one another after the punching process.

According to a further embodiment, the method is developed in that the punching blade of the punching tool supplies a plurality of closed cutting lines which are arranged in a common punching surface of the punching tool. Each cutting line defines a closed tobacco particle punching surface and the tobacco particle punching surfaces fill the punching surface of the punching tool without gaps.

In other words, the individual geometric shape of the tobacco particle punching surfaces is selected such that this shape is suitable for filling a flat surface without gaps. For example, squares, rectangles or even an L-shaped geometry are suitable. Also suitable are triangles or hexagons. Advantageously, by the choice of such a geometry of the tobacco particle punching surfaces, it is avoided that the starting material remains unused during the production of the tobacco particles.

It is also preferably provided that different geometric shapes of the tobacco particles are blended together, so that as a result the entire punching surface is once again filled up without gaps.

In a further advantageous embodiment, the method is developed in that tobacco sheet is supplied as starting material and/or unpressed tobacco leaves are supplied as starting material. Preferably, a mixed processing of tobacco leaves and tobacco sheet is also possible according to the desired blending ratio.

Moreover, according to a further embodiment, it is provided that the starting material includes tobacco leaves and the plurality of punched-out tobacco particles comprises at least two weight fractions. Tobacco particles of a first weight fraction on average have a lower weight than tobacco particles of a second weight fraction, and the tobacco particles of the first fraction substantially exclusively include tobacco leaf lamina and the tobacco particles of the second fraction comprise a rib portion and/or stem portion of a tobacco leaf. The first and the second weight fractions are separated after the punching-out and supplied separately.

Advantageously, the lamina-containing or rib-containing tobacco particles are separated from one another immediately after the production thereof. Thus it is possible to supply them for a specific treatment which, in particular, is variable. The two fractions of the tobacco particles are, for example, supplied to different conditioning, expansion, 3D shaping or flavoring processes. Subsequently, they may be blended together in the desired combination, so that they are present uniformly in a tobacco product supplied from the tobacco particles and in the cigarette strand produced therefrom. It is also possible to eject the rib-containing or respectively stem-containing tobacco particles, and in this manner to undertake a removal of the ribs from the tobacco leaves. To this end, the size of the tobacco particles is selected such that said tobacco particles may comprise a stem or a rib, for example, they have a size of between 5 mm and 15 mm in diameter. Moreover, it is possible to match the size of the tobacco particles to the rib structure or respectively leaf size of the tobacco types used.

The blending of different fractions of tobacco particles is carried out according to the blend and recipe, for example in a drum or a blending silo.

According to a further embodiment, the method is developed by the punching tool, which includes a punching blade, the cutting line thereof being arranged in a punching surface, wherein
the punching surface is a plane and, in particular, the punching-out takes place using a traveling head press as the punching tool, or
the punching surface is a cylindrical outer surface and, in particular, the punching-out takes place by a punch roll as the punching tool.

The punching apparatus with a flat punching surface is, for example, a travelling head press. The punching apparatus with a curved punching surface is, for example, a roll punch or cylinder punch. In both types it may be provided that the tobacco particles which are produced are blown out of the punching tool by compressed air and thus removed.

Embodiments of the invention relate to a device of the tobacco processing industry for producing a particulate tobacco product, including a conveying apparatus, a punching station and a supply apparatus, wherein
the conveying apparatus is designed to convey a supplied flat starting material consisting of tobacco to the punching station in a processing plane,
the punching station comprises a punching tool and is designed to punch out at least one tobacco particle from the starting material using the punching tool,
the supply apparatus is designed to supply a plurality of punched-out tobacco particles as a particulate tobacco product.

The same or similar advantages relate to the device of the tobacco processing industry according to features of the invention, as have already been mentioned with regard to the method for producing a particulate tobacco product according to features of the invention, so a further description is intended to be dispensed with.

The device is preferably further developed such that the punching tool comprises a punching blade with a closed cutting line, wherein a shape of the punched-out tobacco particle may be determined or is determined by the closed shape of the cutting line.

The punching blade is, for example, a strip made of carbon steel or spring steel which is received by a carrier plate and sharpened on one side. Preferably a resilient material, for example rubber, is located in the intermediate spaces between the individual punching blades. This is subsequently compressed and expanded (relaxed) during the punching process, as soon as the punching process is completed. In this manner the punched-out tobacco particles are ejected from the punching tool. It is also possible to provide a pneumatic ejection by the intermediate spaces of the punching blade and/or a spring-mounted metal plate being acted upon by compressed air.

The device is also further developed in that the punching blade of the punching tool supplies a plurality of closed cutting lines which are arranged in a common punching surface of the punching tool, wherein each cutting line defines a closed tobacco particle punching surface and the tobacco particle punching surfaces fill the punching surface of the punching tool without gaps.

Moreover, the device is further developed according to a preferred embodiment in that the starting material comprises tobacco leaves and the plurality of punched-out tobacco particles comprise at least two weight fractions. Tobacco particles of a first weight fraction on average have a lower weight than tobacco particles of a second weight fraction, and the tobacco particles of the first fraction substantially exclusively include of tobacco leaf lamina and the tobacco particles of the second fraction comprise a rib portion and/or stem portion of a tobacco leaf. The device includes a separating apparatus, in particular a sifting apparatus, which is designed to separate the first and the second weight fractions after the punching-out and the supply apparatus is designed to supply the two weight fractions separately.

According to a further embodiment, it is also provided that the punching tool is arranged, in particular exclusively and entirely, on a first side of the processing plane and cooperates with a counterpiece which is arranged on an opposing second side of the processing plane.

The counterpiece or abutment is preferably not part of the punching tool. In other words, therefore, the device according to features of the invention is designed such that the punching tool is arranged entirely on one side of the processing plane.

Finally, embodiments are directed to a use of the device as described above for carrying out the method as described above.

Embodiments of the invention are directed to a method for producing a particulate tobacco product. The method includes conveying a supplied flat starting material comprising tobacco along a processing plane to a punching station; punching out at least one tobacco particle from the starting material using a punching tool of the punching station; and supplying the at least one punched-out tobacco particles as a particulate tobacco product.

According to embodiments, the punching tool can include a punching blade with a closed cutting line, and a shape of the punched-out tobacco particle can be determined by a closed shape of the cutting line.

In accordance with other embodiments, the at least one tobacco particle may be punched out in a single uninterrupted operating step from the starting material. The at least one tobacco particle can be punched out by continuous shearing along the closed cutting line of the punching tool in the single uninterrupted step.

According to other embodiments, the starting material can be supplied in a plurality of individual superimposed layers to the punching station and the punched-out at least one tobacco particle may include a plurality of punched-out tobacco particles that are punched out at a same time and superimposed in a congruent manner.

In still other embodiments, the punching tool can include a punching blade having a plurality of closed cutting lines arranged in a common punching surface, and the closed cutting lines can define a closed tobacco particle punching surface that fills the punching surface without gaps.

In accordance with other embodiments of the invention, the starting material may include at least one of a tobacco sheet and unpressed tobacco leaves.

According to still other embodiments, the starting material can include tobacco leaves and the at least one punched-out tobacco particles can include a plurality of punched-out tobacco particles having at least two weight fractions. Tobacco particles of a first weight fraction may have a lower weight on average than tobacco particles of a second weight fraction, and the tobacco particles of the first fraction can substantially exclusively include tobacco leaf lamina and the tobacco particles of the second fraction may include at least one of rib and stem portions of a tobacco leaf. Moreover, the method can also include separating the first and the second weight fractions after the punching-out and separately supplying the first and second weight fractions as the particulate tobacco product.

In accordance with still other embodiments, the punching tool can include a punching blade having a cutting line arranged in a punching surface, and one of: the punching surface is a plane and the punching tool is a traveling head press, or the punching surface is a cylindrical outer surface and the punching tool is punch roller.

Embodiments of the invention are directed to a device of the tobacco processing industry for producing a particulate tobacco product, which includes a conveying apparatus configured to convey a supplied flat starting material comprising tobacco in a processing plane, a punching station, which is supplied with the starting material from the conveying apparatus, comprises a punching tool configured to punch out at least one tobacco particle from the starting material; and a supply apparatus configured to supply a plurality of punched-out tobacco particles as a particulate tobacco product.

According to embodiments, the punching tool may include a punching blade with a closed cutting line, and a shape of the punched-out tobacco particle can be determined by a closed shape of the cutting line. The closed cutting lines of the punching blade can be arranged in a common punching surface, and the closed cutting lines may define a closed tobacco particle punching surface that fills the punching surface without gaps.

In accordance with other embodiments, the starting material may include tobacco leaves and the at least one punched-out tobacco particle may include a plurality of punched-out tobacco particles having at least two weight fractions. Tobacco particles of a first weight fraction can have a lower weight on average than tobacco particles of a second weight fraction, and the tobacco particles of the first fraction may substantially exclusively include tobacco leaf lamina and the tobacco particles of the second fraction can include at least one of rib and stem portions of a tobacco leaf. Moreover, the device can further include a separating apparatus configured to separate the first and the second weight fractions after the punching-out and the supply apparatus can be designed to supply the two weight fractions separately. The separating apparatus may include a sifting apparatus and the supply apparatus comprises first and second supply apparatuses. Further, the sifting apparatus can be configured to supply the first and second weight fractions to the first and second supply apparatuses, respectively.

According to still other embodiments, the punching tool can be arranged on a first side of the processing plane and can cooperate with a counterpiece arranged on a second side of the processing plane opposite the first side.

In accordance with other embodiments, the punching tool may be arranged entirely on a first side of the processing plane.

Embodiments are directed to a method of operating the above-described device. The method includes conveying a supplied flat starting material comprising tobacco along a processing plane to a punching station; punching out at least one tobacco particle from the starting material using a punching tool of the punching station; and supplying the at least one punched-out tobacco particles as a particulate tobacco product.

In accordance with still yet other embodiments of the present invention, the punched-out at least one tobacco particle may include a punched-out plurality of tobacco particles that can include tobacco particles of a first weight fraction substantially exclusively including tobacco leaf lamina and tobacco particles of a second weight fraction including least one of rib and stem portions of a tobacco leaf. Moreover, the method can include separating the punched-out plurality of tobacco particles into the first and second weight fractions; and separately supplying the separated first and second weight fractions as the particulate tobacco product.

Further features of the invention are revealed from the description of embodiments according to the invention, together with the claims and the accompanying drawings. Embodiments according to the invention may fulfill individual features or a combination of a plurality of features.

In the drawings, in each case the same or similar elements and/or parts are provided with the same reference numerals, so that in each case a further description is dispensed with.

### BRIEF DESCRIPTION OF THE DRAWINGS

The invention is described hereinafter without limiting the general inventive idea using exemplary embodiments with reference to the drawings, wherein relative to all details according to the invention which are not described in more detail in the text reference is expressly made to the drawings, in which:

FIGS. 1 and 2 show in each case a device of the tobacco processing industry for producing a particulate tobacco product in a schematically simplified view;

FIGS. 3 to 6 show in each case partially a plan view of different punching tools; and

FIG. 7 shows a schematic view of the different tobacco particles punched out of a tobacco leaf.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

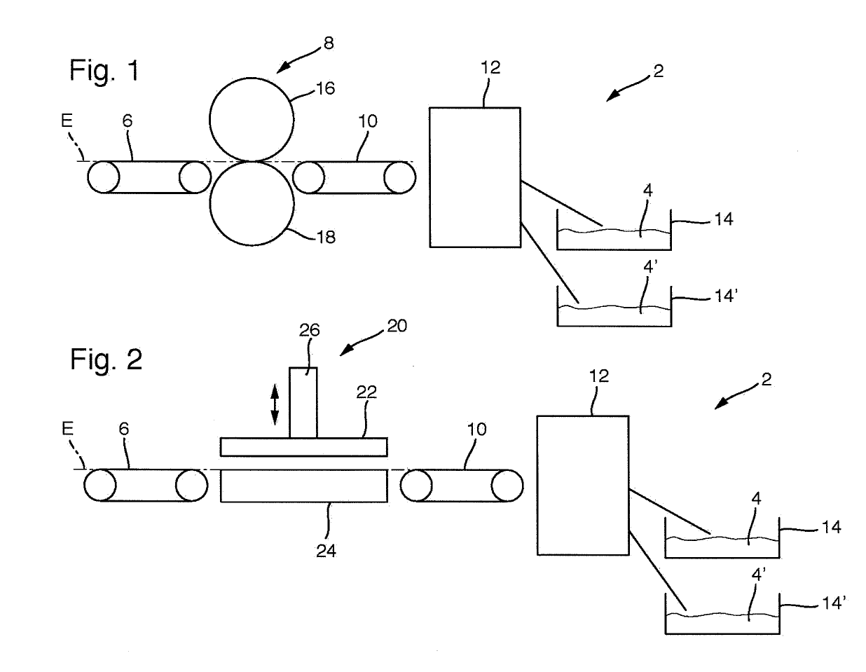

FIG. 1 shows in a schematically simplified view a device 2 of the tobacco processing industry for producing a punched-out particulate tobacco product 4, 4′. The device 2 comprises a conveying apparatus 6, for example, a conveyor belt, a roller punch or roll punch 8 as a punching station, a further conveying apparatus 10 which also may be a conveyor belt and an optional separating apparatus 12, for example, a pneumatic sifter. Pneumatic sifting apparatuses, also called sifters for short, are generally known. One such sifter is disclosed, for example, in DE 10 2005 062 090 B4 of the applicant Hauni Maschinenbau AG, the disclosure of which is expressly incorporated by reference herein in its entirety. The device 2 further comprises supply apparatuses 14, 14′ which, for example, are containers for receiving bulk goods.

Tobacco leaves, preferably whole tobacco leaves, whatever the type, are supplied as starting material to the device 2 for producing a particulate tobacco product 4. Preferably, the tobacco leaves are supplied in a plurality of superimposed layers to the device 2.

It is also provided that a (single layer or preferably multilayer) tobacco sheet from reconstituted tobacco material as the starting material is supplied to the device 2 via the conveying apparatus 6. The starting material including tobacco is supplied to the roller punch or roll punch 8 in a processing plane E defined by the conveying apparatus 6, which is indicated in dashed-dotted lines.

The roller punch or roll punch 8 comprises a punch roller 16 as the punching tool which is arranged entirely above the processing plane E. The punch roller 16 cooperates with a counter roller 18 which is arranged below the processing plane E. The counter roller 18 is not part of the punching tool. The starting material, for example, the tobacco leaves or the tobacco sheet, is subjected to a pressure in the processing gap between the punch roller 16 and the counter roller 18, so that the punching-out process of the tobacco particles from the starting material takes place. The punched-out tobacco particles pass via the further conveying apparatus 10 either directly to a supply apparatus or, as shown in the exemplary embodiment of FIG. 1, to the optionally provided separating apparatus 12. In the separating apparatus 12, the punched-out tobacco particles are separated into at least two weight fractions. These fractions are supplied separately in the two supply apparatuses 14, 14′.

FIG. 2 shows a further device 2 of the tobacco processing industry, which is constructed in a similar manner to the device 2 shown in FIG. 1. Instead of the roller punch or roll punch 8 used in the embodiment of FIG. 1, a traveling head press 20 is provided as the punching station in the exemplary embodiment of FIG. 2. The traveling head press 20 comprises a stamp 22 arranged above the processing plane E which cooperates with a counter-support 24 arranged below the processing plane E. The punch is actuated via a cylinder 26 which, for example, is hydraulic or pneumatic, i.e., moves up and down periodically in the direction of the arrow perpendicular to the processing plane E. The traveling head press 20 includes the stamp 22 as the punching tool.

The punching tools of the devices 2 shown in FIGS. 1 and 2, i.e., the punch roller 16 or the stamp 22, respectively, include on their outer (lower) faces facing the processing plane E in each case a punching blade, not shown, with which the tobacco particles are punched out of the starting material.

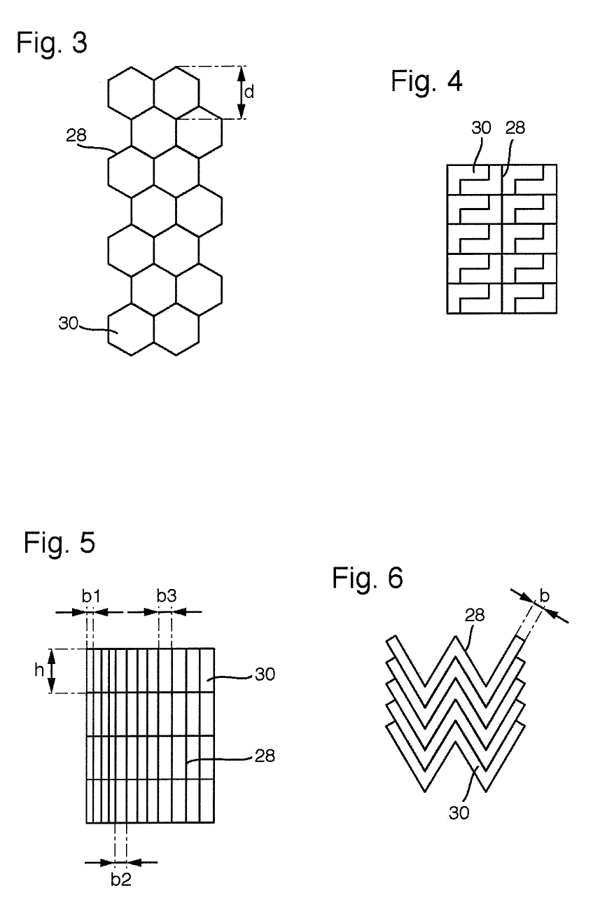

FIGS. 3 to 6 show in a partially schematic and simplified view in each case a plan view of different punching blades as are employed or respectively used according to features of the invention in a device 2 for producing a particulate tobacco product 4.

In FIG. 3 a honeycomb pattern of an exemplary punching blade made up of regular and identically sized hexagons is partially shown. A cutting line 28 of the punching blade which is formed by the cutting edge thereof, encloses each of the honeycombs shown and thus defines the shape of the punched-out tobacco particle. A diameter d of such a tobacco particle punching surface 30 is selected such that this is located approximately in a width of a stem or the rib of the tobacco leaves processed as starting material. The value of the diameter d is, e.g., between 2 mm and 20 mm, preferably approximately 12 mm or 15 mm, and more preferably between 5 mm and 15 mm.

In FIG. 4 a further punching blade is shown partially schematically and simplified in a plan view of its punching surface. In contrast to the punching blade depicted in FIG. 3, the individual tobacco particle punching surfaces 30 are L-shaped, as in FIG. 4, rather than hexagonal. The tobacco particle punching surfaces 30 are in turn in each case entirely surrounded by the cutting line 28 of the punching blade. This predetermines, therefore, the shape of the tobacco particles. The L-shaped tobacco particle punching surfaces 30 have, for example, limb lengths which are the size of the diameter d mentioned in connection with FIG. 3. Thus, they are preferably between 2 mm and 20 mm. The length of the small limb is, e.g., approximately 8 mm, while the length of the large limb is, e.g., approximately 16 mm. The L-shaped surfaces of adjacent tobacco particle punching surfaces 30 are rotated by 180° relative to one another so that in each case two L-shaped surfaces are arranged or added together to form a rectangle.

The L-shaped tobacco particles are advantageous with regard to the volumetric expansion of the produced tobacco product, since in a subsequent treatment such tobacco particles are warped, twisted and bent and optionally interlock with one another. A good volumetric expansion may be achieved in this manner. The same also applies to tobacco particles which are produced by the punching blades shown in FIGS. 5 and 6.

In a punching tool which includes a punching blade having a geometry corresponding to those shown in FIG. 3 or 4, the produced tobacco particles are all of identical shape and size. Thus a very uniform particulate tobacco product 4 is able to be supplied.

FIG. 5 shows a further schematic simplified plan view of a punching blade in partial view. The tobacco particle punching surfaces 30 are rectangular in the case shown. Each of the tobacco particle punching surfaces 30 in turn is entirely surrounded by a cutting line 28 of the punching blade. The rectangular tobacco particles all have an identical height h but three different widths b1, b2 and b3. The size of these dimensions h, b1, b2, b3 in turn is the size of the width of a stem or respectively web of the tobacco leaves, i.e., preferably ranging, e.g., between 2 mm and 20 mm. For example, the width b1, b2 or respectively b3 of the tobacco particles is, e.g., 2 mm, 3 mm or respectively 4 mm. The height h of the tobacco particles is, for example, 12 mm.

With the partially shown punching blade depicted in FIG. 5, tobacco particles of different sizes are produced in a single punching process. In the exemplary embodiment shown, the tobacco particles having the widths b1, b2 or respectively b3 are present in each case in the same number. By varying the number of the respective tobacco particle punching surfaces 30 with regard to their size and shape, the desired distribution of the produced tobacco particles may be adjusted. If, for example, it is desired to increase narrow tobacco particles having the width b1, the number of these tobacco particle punching surfaces 30 would be increased relative to the other punching surfaces 30 having the widths b2 and b3.

It is common to the geometries shown in FIGS. 3 to 5 that the tobacco particle punching surfaces 30 fill the entire punching surface of the punching tool without gaps. In other words, no starting material is lost in the punching-out process; this is entirely converted into punched-out tobacco particles.

FIG. 6 shows in a further partial view a plan view of the punching surface of a further punching tool, wherein the tobacco particle punching surface 30 is now W-shaped. Once again, the individual tobacco particle punching surfaces 30 are entirely surrounded by the cutting line 28. A width b of the W-shaped structure is in turn selected such that it has the same size as the previously cited dimensions d, h, b1, b2 and b3, i.e., in the range, e.g., between 2 mm and 20 mm. FIG. 6 shows an example in which the tobacco particle punching surface 30 is shaped such that it does not entirely fill the punching surface of the punching tool. Small regions of the starting material remain which are not converted into punched-out tobacco particles.

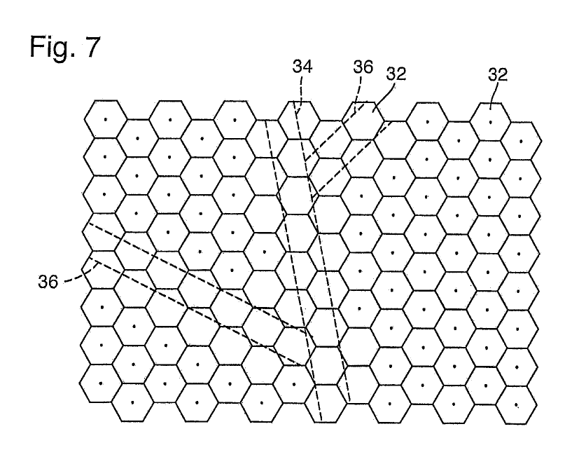

FIG. 7 shows in a schematic view a plurality of tobacco particles 32 punched out of a tobacco leaf, wherein by way of example, a pattern of regular hexagons has been used for the punching-out. Merely for reasons of clarity, only some of the tobacco particles 32 are provided with reference numerals. In FIG. 7 a stem 34 and ribs 36 of a tobacco leaf are indicated schematically by dashed lines. The remaining regions are intended to be tobacco leaf lamina. If such a tobacco leaf in a punching process is now divided into the tobacco particles 32 shown, tobacco particles 32 are produced which exclusively include the lamina and those which include parts of the stem 34 or parts of the ribs 36. Those tobacco particles 32 which exclusively include the lamina are identified in FIG. 7 by a central dot. The remaining tobacco particles 32 which are not provided with a dot comprise a part of the stem 34 or respectively the ribs 36.

Thus, tobacco particles 32 are produced in two different weight fractions. The tobacco particles 32 of the first weight fraction have on average a lower weight than the tobacco particles 32 of the second weight fraction. This is due to the tobacco particles 32 of the first weight fraction substantially, i.e., practically exclusively, consisting of tobacco leaf lamina. This is the tobacco particle 32 marked by a dot.

The tobacco particles 32 of the second fraction which are not provided with a dot, however, comprise rib and/or stem portions (or components) of the tobacco leaf. Both fractions of tobacco particles 32 are present at the outlet of the punching station. These fractions are supplied to the optional separating apparatus 12 which, in particular, is a pneumatic sifting apparatus. Here, the first and the second weight fractions are separated from one another and supplied separately to supply apparatuses 14, 14′ for further processing steps.

For example, the tobacco particles 32 of the first weight fraction are supplied as tobacco product 4 in the supply apparatus 14. The tobacco particles 32 comprising stem components and/or rib components are supplied as tobacco product 4′ in the supply apparatus 14′. In a generally known and conventional manner, the two fractions are subsequently treated separately from one another and optionally blended again with one another for producing the tobacco strand in the strand formation.

In a method for producing a particulate tobacco product 4, 4′, flat starting material which is initially supplied and consists of tobacco, i.e., for example tobacco leaves or tobacco sheet, is conveyed to a punching station in the processing plane E. The tobacco particles 32 are punched out of the starting material in the punching station, using the punching tool. Subsequently, a plurality of punched-out tobacco particles 32 are supplied as a particulate tobacco product. A punching blade of the punching tool, i.e., the punch roller 16 or the stamp 22, preferably has a closed cutting line 28 which determines the shape of the punched-out tobacco particles 32, for example, as shown in FIGS. 3 to 6.

Further preferably, the method for producing the particulate tobacco product 4, 4′ is designed such that the tobacco particles 32 are produced from the starting material in a single uninterrupted operating step. This means, in the case of a roller punch 8, that tobacco particles 32 are punched out by the starting material being moved into the roll gap between the punch roller 16 and the counter roller 18 and the tobacco particles 32 are punched out there in a continuous, i.e., uninterrupted process. In the case of a traveling head press 20, as is shown, e.g., in FIG. 2, the continuous punching-out process takes place by the stamp 22 being lowered in the direction of the counter-support 24 and, therefore, a plurality of tobacco particles 32 are punched out at the same time.

Preferably, a continuous shearing takes place along the closed cutting line 28 of the respective punching tool. In a single operating step, therefore, according to this embodiment the tobacco particle 32 is entirely punched out from the starting material.

For accelerating the production process, it is also provided that the starting material is supplied in a plurality of individual superimposed layers to the punching station. This relates both to the use of tobacco leaves as starting material and tobacco sheet as starting material. Thus, in each punching-out process a plurality of tobacco particles 32 which are superimposed in a congruent manner are punched out at the same time.

The punching blades of the punching tools 16, 22 are designed such that these punching blades in each case supply closed cutting lines 28 which define the shape of the tobacco particles. The tobacco particle punching surfaces 30 which are defined by the closed cutting lines 28 are preferably geometrically selected such that they fill the punching surface of the punching tool 16, 22 without gaps. Examples thereof are the geometries depicted in FIGS. 3 to 5.

If tobacco leaves are used as starting material, at least two weight fractions are present in the punched-out tobacco particles 32. For example, tobacco particles 32 of the first weight fraction on average have a lower weight than the tobacco particles 32 of the second weight fraction since the tobacco particles 32 of the first fraction substantially exclusively consist of tobacco leaf lamina, whilst the tobacco particles 32 of the second fraction comprise rib portions and/or stem portions of the tobacco leaf.

If a punch roller 16 is used as the punching tool, the punching surface is a cylindrical outer surface (FIG. 1). If, however, as shown in FIG. 2, a traveling head press 20 is used as the punching tool, the punching surface is a plane since the punching blade is located on the flat stamp 22.

All of the cited features and also the features to be derived individually from the drawings and also individual features which are disclosed in combination with other features, are regarded individually and in combination as essential to the invention. Embodiments according to the invention may be fulfilled by individual features or a combination of a plurality of features. Within the scope of the invention, features which are qualified by “in particular” or “preferably” are to be understood as optional features.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMERALS

2 Device of the tobacco processing industry
4, 4′ Tobacco product
6 Conveying apparatus
8 Roller punch or respectively roll punch
10 Further conveying apparatus
12 Separating apparatus
14, 14′ Supply apparatus
16 Punch roller
18 Counter roller
20 Traveling head press
22 Stamp
24 Counter-support
26 Cylinder
28 Cutting line
30 Tobacco particle punching surface
32 Tobacco particle
34 Stem
36 Rib
E Processing plane
d Diameter
h Height
b, b1, b2, b3 Width

What is claimed:

1. A method for producing a particulate tobacco product, comprising:
conveying a supplied flat starting material comprising tobacco along a processing plane to a punching station;
punching out at least one tobacco particle from the starting material using a punching tool of the punching station; and
supplying the at least one punched-out tobacco particles as a particulate tobacco product.

2. The method as claimed in claim 1, wherein the punching tool comprises a punching blade with a closed cutting line, wherein a shape of the punched-out tobacco particle is determined by a closed shape of the cutting line.

3. The method as claimed in claim 1, wherein the at least one tobacco particle is punched out in a single uninterrupted operating step from the starting material.

4. The method as claimed in claim 3, wherein the at least one tobacco particle is punched out by continuous shearing along the closed cutting line of the punching tool in the single uninterrupted step.

5. The method as claimed in claim 1, wherein the starting material is supplied in a plurality of individual superimposed layers to the punching station and
wherein, the punched-out at least one tobacco particle comprises a plurality of punched-out tobacco particles that are punched out at a same time and superimposed in a congruent manner.

6. The method as claimed in claim 1, wherein the punching tool comprises a punching blade having a plurality of closed cutting lines arranged in a common punching surface, and
wherein the closed cutting lines define a closed tobacco particle punching surface that fills the punching surface without gaps.

7. The method as claimed in claim 1, wherein the starting material comprises at least one of a tobacco sheet and unpressed tobacco leaves.

8. The method as claimed in claim 1, wherein the starting material comprises tobacco leaves and the at least one punched-out tobacco particles comprises a plurality of punched-out tobacco particles having at least two weight fractions,
wherein tobacco particles of a first weight fraction have a lower weight on average than tobacco particles of a second weight fraction,
wherein the tobacco particles of the first fraction substantially exclusively comprise tobacco leaf lamina and the tobacco particles of the second fraction comprise at least one of rib and stem portions of a tobacco leaf, and
the method further comprises separating the first and the second weight fractions after the punching-out and separately supplying the first and second weight fractions as the particulate tobacco product.

9. The method as claimed in claim 1, wherein the punching tool comprises a punching blade having a cutting line arranged in a punching surface, and
one of:
the punching surface is a plane and the punching tool is a traveling head press, or
the punching surface is a cylindrical outer surface and the punching tool is punch roller.

10. A device of the tobacco processing industry for producing a particulate tobacco product comprising:
a conveying apparatus configured to convey a supplied flat starting material comprising tobacco in a processing plane,
a punching station, which is supplied with the starting material from the conveying apparatus, comprises a punching tool configured to punch out at least one tobacco particle from the starting material; and
a supply apparatus configured to supply a plurality of punched-out tobacco particles as a particulate tobacco product.

11. The device as claimed in claim 10, wherein the punching tool comprises a punching blade with a closed cutting line, and a shape of the punched-out tobacco particle is determined by a closed shape of the cutting line.

12. The device as claimed in claim 11, wherein the closed cutting lines of the punching blade are arranged in a common punching surface, and
wherein the closed cutting lines define a closed tobacco particle punching surface that fills the punching surface without gaps.

13. The device as claimed in claim 10, wherein the starting material comprises tobacco leaves and the at least one punched-out tobacco particle comprises a plurality of punched-out tobacco particles having at least two weight fractions,
wherein tobacco particles of a first weight fraction have a lower weight on average than tobacco particles of a second weight fraction,
wherein the tobacco particles of the first fraction substantially exclusively comprise tobacco leaf lamina and the tobacco particles of the second fraction comprise at least one of rib and stem portions of a tobacco leaf, and
wherein the device further comprises a separating apparatus configured to separate the first and the second weight fractions after the punching-out and the supply apparatus is designed to supply the two weight fractions separately.

14. The device as claimed in claim 13, wherein the separating apparatus comprises a sifting apparatus and the supply apparatus comprises first and second supply apparatuses.

15. The device as claimed in claim 14, wherein the sifting apparatus is configured to supply the first and second weight fractions to the first and second supply apparatuses, respectively.

16. The device as claimed in claim 10, wherein the punching tool is arranged on a first side of the processing plane and cooperates with a counterpiece arranged on a second side of the processing plane opposite the first side.

17. The device as claimed in claim 10, wherein the punching tool is arranged entirely on a first side of the processing plane.

18. A method of operating the device as claimed in claim 10, comprising:
conveying a supplied flat starting material comprising tobacco along a processing plane to a punching station;
punching out at least one tobacco particle from the starting material using a punching tool of the punching station; and
supplying the at least one punched-out tobacco particles as a particulate tobacco product.

19. The method as claimed in claim 18, wherein the punched-out at least one tobacco particle comprises a punched-out plurality of tobacco particles that comprise tobacco particles of a first weight fraction comprising substantially exclusively tobacco leaf lamina and tobacco particles of a second weight fraction comprising at least one of rib and stem portions of a tobacco leaf, and
the method further comprises:
separating the punched-out plurality of tobacco particles into the first and second weight fractions; and
separately supplying the separated first and second weight fractions as the particulate tobacco product.
